(19) United States
(12) Patent Application Publication
(10) Pub. No.: US 2007/0041223 A1
(43) Pub. Date: Feb. 22, 2007

(54) Optocouplerless switched mode power supply

(75) Inventor: Pieter Jan Mark Smidt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/578,642

(22) PCT Filed: Nov. 8, 2004
(86) PCT No.: PCT/IB04/52332

§ 371 Date: May 9, 2006

(30) Foreign Application Priority Data
Nov. 14, 2003 (EP) 03104199.9

(51) Int. Cl. H02M 3/335

(52) U.S. Cl. 363/21.01

(57) ABSTRACT

The present invention relates to a switched mode power supply (10, 20). The basic idea of the present invention is that excess magnetic energy still present in the supply transformer when the current of the transformer commutates from the primary side to the secondary side will be transferred to an auxiliary voltage output (Vaux). The auxiliary output voltage is controlled by a sensing means (18, 28) on the primary side of the transformer. The sensing means regulates the auxiliary output voltage by sensing the voltage of the auxiliary output via the transformer. The voltage across the sensing means is directly related to the excess energy of the transformer. This will signal to a primary control circuit (14, 24) to increase/decrease the on-time of a first transistor (13, 23) and increase/decrease the auxiliary output voltage to the desired value. In this way, the excess energy is regulated, whereby the main output voltage (Vout) is regulated to a predetermined level.

The present invention relates to a switched mode power supply comprising a switched mode power supply transformer arranged with a primary winding and a secondary winding, a first transistor arranged on the primary side of the power supply to control the conduction of current through the primary winding of the switched mode power supply transformer, a primary control circuit arranged to control the conduction of current through the first transistor and a second transistor connected to the secondary winding, which second transistor is arranged to charge an output capacitor and thereby create a power supply main output voltage across said capacitor.

Normally, in Switch Mode Power Supplies (SMPS), an optocoupler is used to regulate the output of the SMPS to the required value.

The optocoupler is typically connected in a feedback path from the secondary side to the primary side of the SMPS, optically isolating the feedback path of the secondary side from the primary side. The feedback path is connected to primary side control electronics for controlling a switching transistor connected in a series arrangement with the primary winding of the transformer. The switching transistor controls the conduction of current through the primary winding. Because of the feedback path, the frequency with which the switching transistor is switched on and off will decrease as the SMPS output voltage reaches a predetermined level, thereby controlling the SMPS output. Alternatively, other parameters such as duty cycle or peak current might be used to control the SMPS output. A major drawback with this type of SMPS is the cost of the optocoupler. In particular when the optocoupler shall comply with harsh requirements, the price of the optocoupler increases rapidly.

Two alternative solutions are used to eliminate the use of an optocoupler. First, primary sensing can be employed, wherein the output voltage is measured on the primary side of the transformer via a sensing winding on the transformer. The major disadvantage with this method is the poor accuracy of the output voltage: the output voltage will vary considerably with varying input voltage and load conditions. If the device connected to the power supply cannot deal with these variations, another method is used known as post regulation. The output voltage which is controlled by the primary side is stabilized by a controllable resistor (such as a transistor), wherein the excess power transferred to the secondary side of the power supply is dissipated. Thereby, it is possible to achieve a well-stabilized output voltage. The major disadvantages with this method are poor efficiency, added cost for components which may include a heat sink and the size of the design due to added components and higher overall power dissipation.

U.S. Pat. No. 5,781,420 discloses a switched mode power supply including a transformer having a primary winding electrically connected to a primary switch and a secondary switch and a clamping capacitor. The clamping capacitor stores the magnetization energy from the secondary winding when the primary switch is turned off, thus causing the transformer core to be reset during the period of time that the primary switch remains off. The converter can use MOSFETs as the primary and secondary switches, such that a change in the voltage at the secondary winding of the transformer, due to the turning off of the primary switch, results in an automatic turning on of the secondary switch.

A problem associated with U.S. Pat. No. 5,781,420 is that, since it does not contain a feedback path from the secondary side of the SMPS to the primary side, the accuracy of the output voltage control will be poor.

An object of the present invention is to solve the above addressed problems and to provide a power supply offering high efficiency and accuracy.

This object is attained by a switched mode power supply in accordance with claim 1.

Preferred embodiments of the invention are defined by the dependent claims.

According to an aspect of the invention, a secondary control circuit is arranged to measure the main output voltage of the supply to control the conduction of current through the second transistor, whereby the main output voltage is controlled. Further, the supply has an auxiliary voltage output to which excess transformer energy will be transferred when the main output voltage of the supply has been controlled to a predetermined level. Additionally, the switched mode power supply transformer is arranged with a sensing means, and the voltage across the sensing means is directly related to the excess energy of the transformer, and consequently the auxiliary output voltage. The voltage across the sensing means is employed to control, by means of the primary control circuit, the conduction of current through said first transistor and thus the voltage at the auxiliary output. Thereby, the excess transformer energy is controlled.

The basic idea of the present invention is that first, to switch the input voltage of the power supply across a transformer to the main output of the power supply, a first transistor is turned on by a primary control circuit, and thereby the current of the primary transformer rises to a predetermined value. The first transistor is then turned off, resulting in the fact that the current of the transformer commutates to the secondary side where a second transistor is turned on and charges an output capacitor. After a time period which is controlled by a secondary control circuit, the second transistor is turned off, in order to stabilize the main power supply output voltage at a predetermined desired value. Excess magnetic energy still present in the transformer will then be transferred to an auxiliary voltage output taken across an auxiliary output capacitor.

The amount of energy transferred to the main output depends on the on-time of the second transistor. This has the effect that the second transistor will be turned off by the secondary control circuit when enough energy has been transferred to the main output. The remaining energy still present in the transformer must be transported to the auxiliary output, where a small load is present for regulation purposes. The load may consist of leakage resistance in the auxiliary output capacitor. A diode, which is connected in series with the auxiliary output, will start to conduct and the remaining part of the magnetic transformer energy is transferred to the auxiliary output. The auxiliary output voltage is controlled by a sensing means, e.g. a sensing winding, on the primary side of the transformer and can be used for providing the proper drive voltage to the second transistor.

The sensing winding regulates the auxiliary output voltage by sensing the voltage of the auxiliary output via the transformer. The voltage across the sensing winding is directly related to the auxiliary output voltage; if the auxiliary output voltage decreases, the sense voltage will decrease as well. This will signal the primary control circuit to increase the on-time of the first transistor and increase the auxiliary output voltage to the desired value. In case the auxiliary output voltage should rise too high, the voltage across the sensing winding will also rise, which signals the primary control circuit to decrease the on-time of the first transistor, whereby the auxiliary output voltage drops to the desired value. In this way, the excess energy is regulated, whereby the main output voltage is regulated to a predetermined level.

The present invention is advantageous, since the same steady state behavior as when using an optocoupler is attained without using an optocoupler, and still the primary side is isolated from the secondary side. At wish, the number of voltage outputs can be increased by adding additional windings and circuitry. The same holds for auxiliary outputs, if this is required. The power supply according to the present invention circumvents costly, bulky and dissipative circuitry for regulating the output voltage(s) of a switched mode power supply. A great advantage associated with the present invention is that the excess energy is transferred to the auxiliary output where it can be advantageously used to feed various electronic devices.

According to an embodiment of the invention, the auxiliary output is arranged such that the auxiliary output voltage is delivered from the secondary winding of the transformer. The auxiliary output voltage can thus be used to feed secondary-side electronics such as secondary-side control electronics.

According to another embodiment of the invention, the auxiliary output is arranged such that the winding which the auxiliary output is connected to also is the sensing winding of said transformer. The auxiliary output voltage can thus be used to feed primary side electronics such as the first transistor and can also be used as a voltage control for controlling the first transistor.

Further features of, and advantages with, the present invention will become apparent when studying the appended claims and the following description. Those skilled in the art realize that different features of the present invention can be combined to create embodiments other than those described in the following.

Preferred embodiments of the invention will be described with reference made to the accompanying drawings in which:

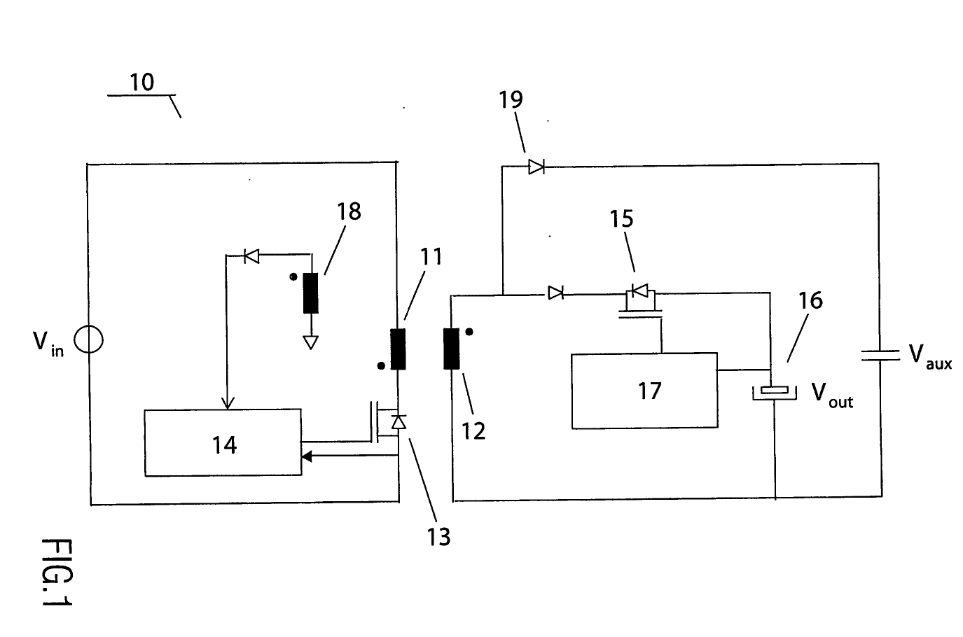

FIG. 1 shows a schematic view of a switched mode power supply according to an embodiment of the present invention; and

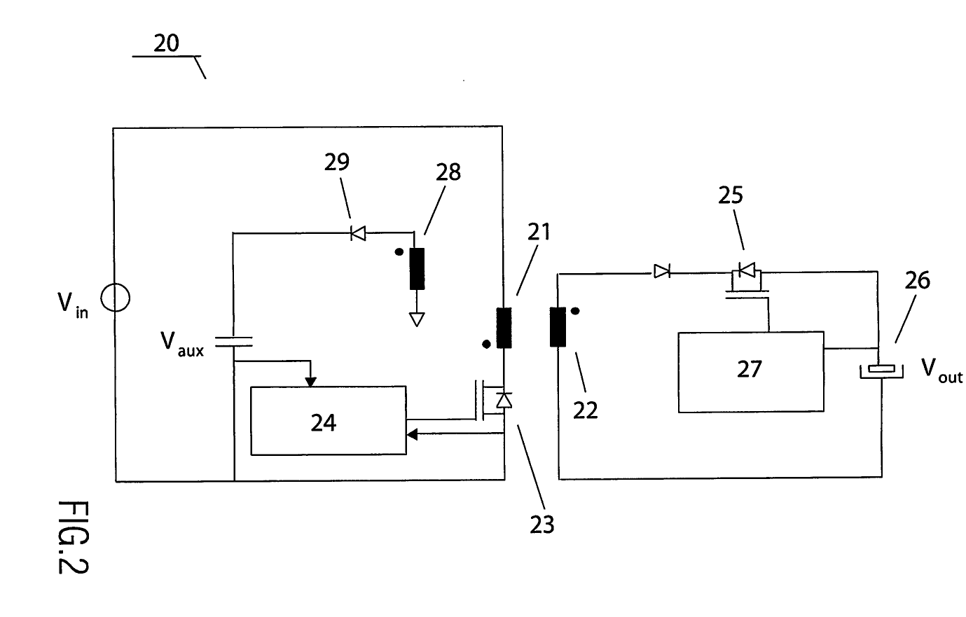

FIG. 2 shows a schematic view of a switched mode power supply according to another embodiment of the present invention.

FIG. 1 illustrates the principles of a switched mode power supply according to an embodiment of the present invention. An input voltage Vin is applied to the power supply 10. This voltage can be either AC or DC, and in the case it is an AC voltage, the power supply normally comprises a full-wave bridge rectifier and a filter for filtering and smoothing the AC input voltage. However, FIG. 1 is employed for illustrative purposes, and thus the AC related circuitry is not shown. The input voltage of the power supply is switched via a transformer comprising a primary winding 11 and a secondary winding 12 to the main output Vout of the power supply. A first transistor 13, typically a MOSFET (metal-oxide semiconductor, field-effect transistor) is chosen due to its power capacity, is operated in its conducting mode by a primary control circuit 14. The current of the primary transformer thereby rises to a predetermined value. The primary control circuit is formed by non-complex electronic elements, such as resistors forming a voltage divider.

The first transistor is then operated in its non-conducting mode by the primary control circuit and the current will thereby cease to flow through the primary winding. Consequently, the current of the transformer commutates to the secondary side, where a second transistor 15 is operated in its conducting mode and charges an output capacitor 16 over which the main output voltage is taken. The main output voltage is measured by a secondary control circuit 17, which is also formed by non-complex elements in analogy with the primary control circuit. Based on the main output voltage, the secondary control circuit controls the conduction of current through the second transistor, thereby controlling the voltage, i.e. the main output voltage, stored in the capacitor. When the main output voltage has stabilized to a predetermined voltage level, the second transistor is operated in its non-conducting mode. Excess magnetic energy still present in the transformer will then be transferred to an auxiliary voltage output Vaux.

A diode 19 connected in series with the auxiliary output will start to conduct and the remaining part of the magnetic transformer energy, i.e. the excess magnetic energy still present in the transformer, is transferred to the auxiliary output. The auxiliary output voltage is controlled by means of a sensing winding 18. The sensing winding regulates the auxiliary output voltage by sensing the magnetic flux of the transformer. The voltage across the sensing winding is directly related to the auxiliary output voltage. If the auxiliary output voltage decreases, the sense voltage will decrease and vice versa An eventual AC voltage across the sense winding is rectified by a diode on the primary side—and possibly filtered by a capacitor (not shown) or sampled—to give a DC reference voltage. This reference voltage is employed to control, by means of the primary control circuit, the conduction of current through the first transistor and thereby the voltage Vaux at the auxiliary output. The auxiliary output voltage can, for example, be used as a supply voltage for the second transistor 15 or any other suitable secondary-side electronics.

If the auxiliary output is unloaded, the excess energy delivered by the transformer must be zero. This is regulated by the primary sensing winding 18 and the primary control circuit 14. As previously described, the voltage across the sensing winding is directly related to the auxiliary output voltage, and if the auxiliary output voltage decreases or increases, the sense voltage will also decrease or increase, respectively. This will decrease or increase the conduction of current through the first transistor and eventually completely regulate the auxiliary output voltage to the predetermined, desired voltage level. Thus, when there is no load on the auxiliary output, no energy is drawn from the auxiliary output, and the auxiliary output voltage will remain at the level set by means of the first transistor. This will result in zero energy delivered to the auxiliary output. For regulation purposes, a small load may be connected to the auxiliary output.

FIG. 2 illustrates the principles of a switched mode power supply according to another embodiment of the present invention. With regard to FIG. 1, like reference numbers indicate the same or similar elements.

An input voltage Vin is applied to the power supply 20 and a first transistor 23 is operated in its conducting mode by a primary control circuit 24. Thus, the current of the primary transformer rises to a predetermined value. The first transistor is then switched off by the primary control circuit and no current flows through the primary winding 21 of the power supply transformer. The current of the transformer commutates to the secondary winding 22 of the transformer, where a second transistor 25 is turned on and charges an output capacitor 26 over which the main output voltage Vout is taken. A secondary control circuit 27 measures the main output voltage, and based on the main output voltage, the secondary control circuit controls the conduction of current through the second transistor, thereby controlling the voltage, i.e. the main output voltage, stored in the capacitor. When the main output voltage has stabilized to a predetermined voltage level, the second transistor is switched off and excess magnetic energy still present in the transformer will then be transferred to an auxiliary voltage output Vaux. In this second embodiment, the auxiliary voltage output is located on the primary side of the supply.

A diode 29 connected in series with the auxiliary output will start to conduct and the remaining part of the magnetic transformer energy is transferred to the auxiliary output. The auxiliary output voltage is controlled by means of a sensing winding 28. Again, the voltage across the sensing winding is directly related to the auxiliary output voltage. If the auxiliary output voltage decreases/increases, the sense voltage will decrease/increase. The sense voltage is employed to control, via the primary control circuit, the conduction of current through the first transistor and thereby the auxiliary output voltage. The auxiliary output voltage can, for example, be used as a supply voltage for the first transistor 23 or any other suitable primary side electronics.

In this embodiment of the invention, the excess energy delivered by the transformer must also be zero if the auxiliary output is unloaded. This is regulated by the primary sensing winding 28 and the primary control circuit 24, as previously described in connection with FIG. 1.

Even though the invention has been described with reference to specific exemplifying embodiments thereof, many different alterations, modifications and the like will become apparent to those skilled in the art. The embodiments described are therefore not intended to limit the scope of the invention, as defined by the appended claims.

1. A switched mode power supply (10, 20) comprising:
a switched mode power supply transformer arranged with a primary winding (11, 21) and a secondary winding (12, 22);
a first transistor (13, 23) arranged on the primary side of the power supply to control the conduction of current through the primary winding of the switched mode power supply transformer;
a primary control circuit (14, 24) arranged to control the conduction of current through said first transistor; and
a second transistor (15, 25) connected to the secondary winding, which second transistor is arranged to charge an output capacitor (16, 26) and thereby create a power supply main output voltage (Vout) across said capacitor; which switched mode power supply is characterized in that it comprises:
a secondary control circuit (17, 27) arranged to measure the main output voltage of the supply to control the conduction of current through said second transistor, thereby controlling the main output voltage;
an auxiliary voltage output (Vaux) to which excess transformer energy will be transferred when the main output voltage of the supply has been controlled to a predetermined level; and
a sensing means (18, 28) on the switched mode power supply transformer, the voltage across which sensing means being directly related to the excess transformer energy, and consequently the auxiliary output voltage, wherein the voltage across the sensing means is employed to control, by means of the primary control circuit, the conduction of current through said first transistor and thus the voltage at the auxiliary output, thereby controlling the excess transformer energy.

2. The switched mode power supply (10) according to claim 1, wherein said auxiliary output (Vaux) is arranged such that the auxiliary output voltage is delivered from the secondary winding (12) of said transformer.

3. The switched mode power supply (10) according to claim 2, wherein the auxiliary output (Vaux) voltage is arranged to feed secondary-side electronics (15, 17).

4. The switched mode power supply (20) according to claim 1, wherein said auxiliary output (Vaux) is arranged such that the auxiliary output voltage is delivered from the sensing means (28) of said transformer.

5. The switched mode power supply (20) according to claim 4, wherein the auxiliary output (Vaux) voltage is arranged to feed primary-side electronics (23, 24).

6. The switched mode power supply (10, 20) according to claim 1, further comprising:
a diode (19, 29) connected in series to the auxiliary voltage output (Vaux), which diode is arranged such that, when the second transistor (17, 27) is turned off, said diode will start to conduct, which results in the fact that energy is delivered to the auxiliary voltage output.

7. The switched mode power supply (10, 20) according to claim 1, wherein said sensing means (18, 28) comprises a sensing winding.
